(19) United States
(12) Patent Application Publication
(10) Pub. No.: US 2003/0014477 A1
(43) Pub. Date: Jan. 16, 2003

(54) Integrated system and method of providing online access to files

(76) Inventors: David Mig Oppenheimer, Fairfax, VA (US); Kevin Limperos, Hoboken, NJ (US); Matthew Hunt, New York City, NY (US)

Correspondence Address: SNELL & WILMER, ONE ARIZONA CENTER, 400 EAST VAN BUREN, PHOENIX, AZ, 850040001

(21) Appl. No.: 09/815,062

(22) Filed: Mar. 22, 2001

Related U.S. Application Data
(60) Provisional application No. 60/191,085, filed on Mar. 22, 2000.

(51) Int. Cl. G06F 15/16

(52) U.S. Cl. 709/203

(57) ABSTRACT

An integrated communications system for exchanging data messages on a data network suitably includes an interface configured to receive said data messages via the data network; a plurality of application servers configured to process data messages and to create output messages in response thereto; and a messenger service configured to route data and output messages between the application servers and users.

A method for exchanging data messages on a data network suitably includes receiving data messages at an interface; routing data messages from the interface to an application server with a messaging service; processing the data messages at an appropriate application server to create output messages in response thereto; and providing output messages to a recipient via the messaging service.

An exemplary client application suitably includes a network interface module configured to send and receive messages via a digital network; a file transfer module configured to transfer data files between a local storage medium and a remote storage medium via the network interface module; an instant messaging module configured to transfer instant messages between the user and another user via the network interface module; and a user interface module configured to display data files and instant messages for the user, and to accept inputs from the user.

THIS APPLICATION CLAIMS PRIORITY OF UNITED STATES PROVISIONAL PATENT APPLICATION SERIAL No. 60/191,085 FILED Mar. 22, 2000, WHICH IS INCORPORATED HEREIN BY REFERENCE IN ITS ENTIRETY.

### FIELD OF INVENTION

The invention relates generally to systems and methods for providing digital content via a computer network. More particularly, the invention relates to user interfaces for searching, obtaining, viewing and processing files and information via a computer network such as the Internet.

### BACKGROUND OF THE INVENTION

Digital networks such as the Internet have greatly revolutionized information sharing between individuals, corporate departments, and the like. Applications such as email, the World Wide Web (WWW), file transfer, remote logon and the like have greatly simplified the way people communicate and have greatly increased the amount of information available to various users.

As the amount of information increases, however, many users have noticed that finding and using such a large volume of information can become unwieldy. Personal information managers such as the Microsoft Outlook product available from the Microsoft corporation of Redmond, Wash., for example, provides integrated access to calendar, schedule and email information. Such programs typically utilize proprietary protocols for information access and retrieval, however, making their use over a public network (e.g. the Internet) impractical. Similarly, such programs typically do not provide file transfer services or storage of files and data in a convenient location on the newtork. In recent years, many new services have attempted to expand the functionality of digital networks such as the Internet. The Napster service, for example, provides free access to literally millions of free digital audio files that are distributed amongst millions of users throughout the globe. The Napster service is limited to MP3 files, however, and does not provide a seamless integration of multiple applications.

Similarly, the America Online (AOL) and other internet provider services provide email and instant messaging functionality through the Internet, but do not typically integrate functions such as calendar, email, file sharing, instant messaging and the like into a common application so that data may be easily processed and shared. Moreover, new services such as Idrive and Xdrive provide remote file sharing, but do not otherwise integrate user functionalities into a common application. It is therefore desired to create an application that integrates file sharing, instant messaging and the like into a common application. It is additionally desired that such an application would store information remotely on a digital network so that information is available to users accessing the application from home, work, travel, or the like.

Brief Description of Exemplary Embodiments

An integrated communications system for exchanging data messages on a data network suitably includes an interface configured to receive said data messages via the data network; a plurality of application servers configured to process data messages and to create output messages in response thereto; and a messenger service configured to route data and output messages between the application servers and users.

A method for exchanging data messages on a data network suitably includes receiving data messages at an interface; routing data messages from the interface to an application server with a messaging service; processing the data messages at an appropriate application server to create output messages in response thereto; and providing output messages to a recipient via the messaging service.

An exemplary client application suitably includes a network interface module configured to send and receive messages via a digital network; a file transfer module configured to transfer data files between a local storage medium and a remote storage medium via the network interface module; an instant messaging module configured to transfer instant messages between the user and another user via the network interface module; and a user interface module configured to display data files and instant messages for the user, and to accept inputs from the user.

### BRIEF DESCRIPTION OF THE DRAWINGS

The above and other features and advantages are hereinafter described in the following detailed description of illustrative embodiments to be read in conjunction with the accompanying drawing figures, wherein like reference numerals are used to identify the same or similar parts in the similar views, and:

FIGS. 1A and 1B are user interfaces for an exemplary pod application;

FIG. 2 is a block diagram for an exemplary server system;

FIG. 3 is a flowchart of an exemplary login process;

FIG. 4 is a flowchart of an exemplary data transfer operation;

FIG. 5A is a user interface for an exemplary instant message function;

FIG. 5B is a flowchart for an exemplary instant message function;

FIG. 6A is a user interface for an exemplary file transfer function;

FIG. 6B is a flowchart for an exemplary file transfer function; and

FIGS. 7A-E are user interfaces for other exemplary functions of an exemplary pod application.

### DETAILED DESCRIPTION OF EXEMPLARY EMBODIMENT

Various embodiments of the invention provide a computerized tool (referred to herein as a “pod application”, “pod”, “client”, “client application” or simply “the application”) for users to view, share, modify, communicate, create and/or store information via a digital network. The pod application suitably performs various functions in conjunction with a server, which may be in logical communication with the pod application via a computer network such as the Internet, a corporate intranet, an extranet, or the like.

Exemplary functions performed by various embodiments of the pod application may include file management; browsing and searching a file system or a network; sending and receiving emails and instant messages (IMs); participating in chat rooms; managing and maintaining personalized buddy lists; playing multimedia files such as video, audio or other multimedia files; providing users with security control and application customization; providing scheduling and/or calendar functions; linking to advertisements for web pages, other pod applications, products, services or the like; viewing pods belonging to other users or services; dragging and dropping files or other information between pods; and providing a tool for creating customized skins to have the pod reflect user personality. Pod applications may also integrate multiple functionalities described above such that file sharing, instant messaging, email and the like (for example) are handled by a single common application. In various embodiments, data for the pod application is stored on a network server so that users have seamless access to their data from multiple computers, remote locations, while travelling, and the like. The pod application may further have the effect of building a community of users, all interacting through a common platform for sharing information and exploiting the network to its fullest.

The systems and processes described herein may be described herein with reference to functional block components and various processing steps. It should be appreciated that such functional blocks may be realized by any number of hardware and/or software components configured to perform the specified functions. The systems described herein, for example, may employ various client and server computers including conventional hardware components, e.g., memory elements, processing elements, logic elements, look-up tables, and the like, which may carry out a variety of functions under the control of one or more microprocessors or other control devices. Similarly, the software elements described herein may be implemented with any programming or scripting language such as C, C++, Visual C++ (available from the Microsoft Corporation of Redmond, Wash.), PASCAL, Java, assembler, PERL, PHP, any database programming language or the like, with the various algorithms being implemented with any combination of data structures, objects, processes, routines or other programming elements. Similarly, the invention could be used in conjunction with any type of personal computer, network computer, workstation, server, minicomputer, mainframe, or other computer running any version of Windows, MacOS, BeOS, Linux, UNIX, Solaris or any other operating system. Further, it should be noted that the present invention might employ any number of conventional techniques for data transmission, signaling, data processing, network control, and the like. For example, radio frequency (RF) or other wireless techniques could be used in place of any network technique described herein. Moreover, although the invention is frequently described herein as being implemented with TCP/IP communications protocols, it will be readily understood that the invention could also be implemented using IPX, Appletalk, IP3, IP-6, NetBIOS, OSI or any number of existing or future protocols.

It should be appreciated that the particular implementations shown and described herein are illustrative of the invention and are not intended to limit the scope of the invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships, logical relationships and/or physical couplings between the various elements. It should be noted that many alternative or additional functional relationships or physical connections may be present in a practical system.

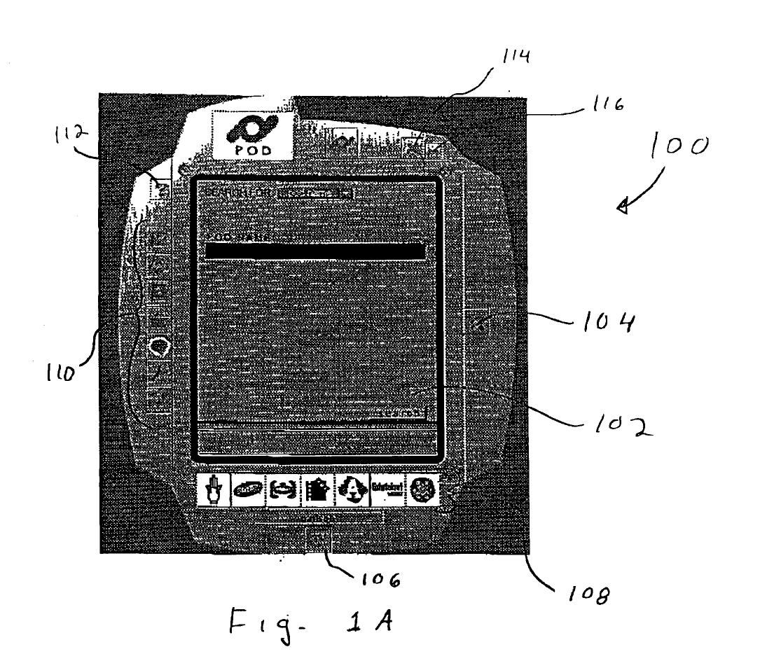

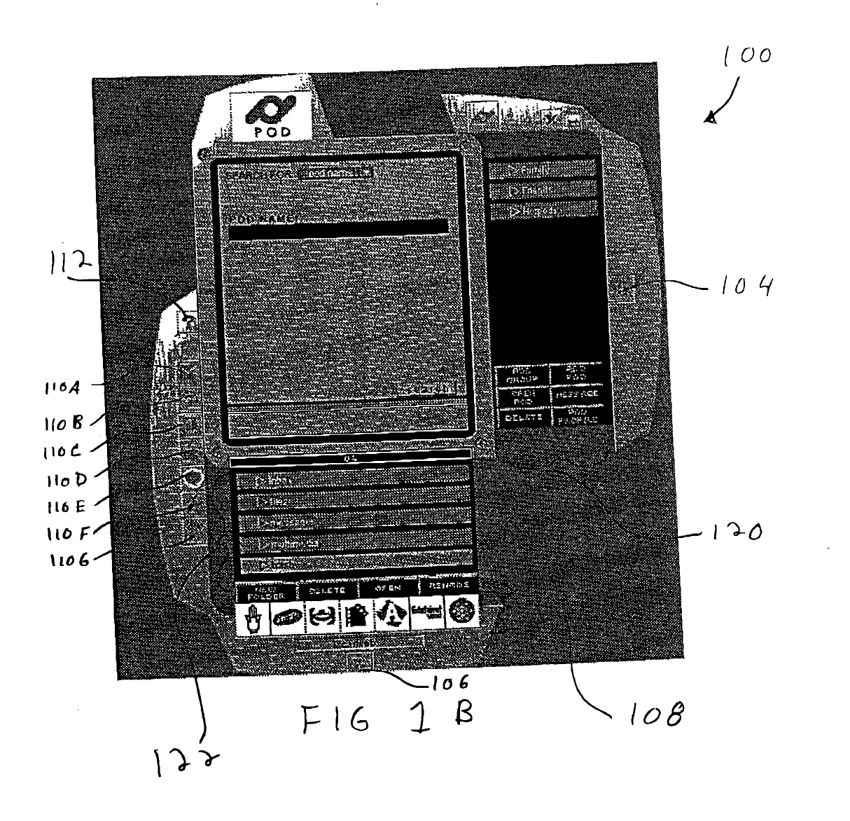

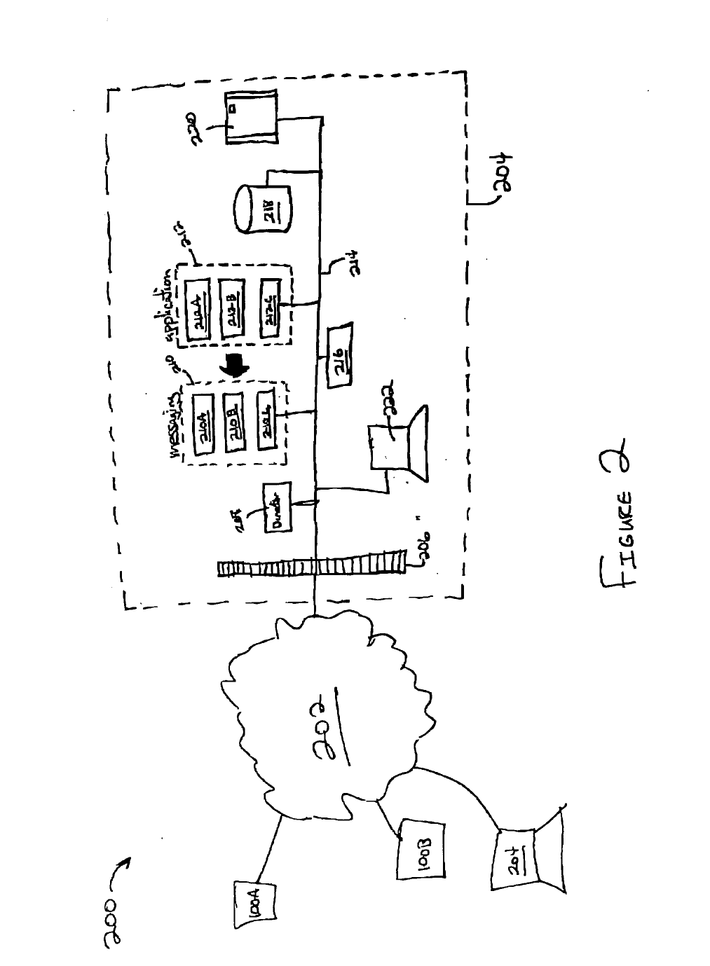

FIGS. 1A and 1B show user interfaces suitable for use with an exemplary client application 100 (also referred to herein as a “pod application”). With reference to FIG. 1A, client application 100 may be a computer application, applet, or other program that runs on a client computer (such as a personal computer, personal digital assistant, network computer, workstation or other computer). In an exemplary embodiment (such as the embodiment shown in FIG. 1), client application 100 executes on a personal computer running any of the Windows operating systems available from the Microsoft Corporation of Redmond, Wash., the MacOS operating system available from the Apple Corporation of Cupertino, Calif., the LINUX operating system available from a number of free sources, or any other operating system.

FIG. 1A shows an exemplary pod application interface in a “closed” or “compact” state. With continued reference to FIG. 1A, client application 100 suitably includes a central display window 102, expansion buttons 104 and 106, advertisements 108, function activation buttons 110, a help button 112, and/or window minimize and close buttons 116 and 114 (respectively). Central display window 102 may interface with a conventional browser application such as any version of the Internet Explorer available from Microsoft or Netscape Navigator available from the Netscape Corporation of Mountain View, Calif. In such embodiments, central display window suitably displays files in HTML, PDF or another suitable format. Expansion buttons 104/106 expand the interface to client application 100 as appropriate, and as described more fully below in conjunction with FIG. 1B. Optional advertisements 108 may be graphical images in GIF, TIFF, JPEG or any other format, and may be linked via hypertext to web pages on the Internet or another network. In other embodiments, advertisements 108 may be eliminated or may be re-configured to provide links to web sites or data services, links to departments or other services available via a corporate internet, or for any other purpose. Function activation buttons 110 may be selected by a user to choose a particular service or application desired. Exemplary function activation buttons 10 suitably include buttons to activate email 110A, playing multimedia files 110B, calendar 110C, file sharing and searching 110D, messaging 110E, pod utilities (such as changing skins, passwords, etc.) 110F, and pod search functions 110G. Optional help button 112 may provide a link to a help menu or display that may be shown in display window 102 as requested by the user. Such a help display may provide information about using client application 100, configuration issues, troubleshooting, and the like. Window close and minimize buttons 114 and 116 are conventional buttons associated with many applications for closing or minimizing the interface to client application 100, and these buttons may be altered, replaced, or eliminated depending upon the particular embodiment and operating system being run by the user. Of course the displays and interfaces discussed herein are for explanatory purposes only, and may vary significantly from embodiment to embodiment. Certain buttons (such as expansion buttons) may be moved, changed or eliminated in other embodiments, for example. Similarly, function activation buttons 110 may be augmented, replaced, or altered significantly depending upon the particular functions provided by any particular embodiment of client application 100. Moreover, various embodiments provide the ability to create “skins” or customizable interfaces to client application 100. Such customizations may be performed with a development tool (such as a skin development kit (SDK) and may be stored on a server, as described more fully below.

FIG. 1B shows a user interface for an exemplary “expanded” view of client application 100. With reference to FIG. 1B, client application 100 has been expanded in response to user activation of expansion buttons 104 and 106 to reveal a contacts window 120 and a data management window 122. Of course not all embodiments of client application 100 are expandable, and many forms of expansion to reveal additional data windows could be formulated. With reference again to FIG. 1B, contacts window 120 may include lists of other pod applications of interest to the user, such as pods belonging to friends, family, “buddies”, coworkers, office or department mates, or the like. Window 120 may also include buttons to add new buddy groups or pods to the list, to open or delete pods already in the lists, to send an email or instant message to another pod, to obtain more information about a pod (e.g. a “pod profile”) or any other functions as appropriate. Data management window 122 suitably includes menus or lists for managing an email inbox, files stored within client application 100, messages, multimedia files (such as MPEG, MP3, streaming audio or video files, or the like). A trash list for discarded files, messages, emails and the like may also be provided.

To use client application 100, a user suitably selects a function from function select buttons 110 and provides input as appropriate via display window 102, contacts window 120, data management window 122, or the like. To send an instant message to another pod application user, for example, a user might select messaging button 110E, then select a message recipient from a buddy list in window 120. Display window 102 suitably prompts the user to enter a message via a keyboard and mouse, pen input, or other input device, and the message is appropriately sent. Various embodiments also allow the user to attach a file (such as a graphics or sound file) to the message by selecting the file from data management window 122. Files and other data associated with each user's client application 100 may be stored on a server on a digital network so that files, data, messages and the like are available from any location where the user obtains access to the network. A user may access the same pod from computers at home and work, for example, as well as from airport kiosks, personal digital assistants, and the like. Because information associated with client application 100 may be stored on a network server, the data is available to the user from any location having access to the network.

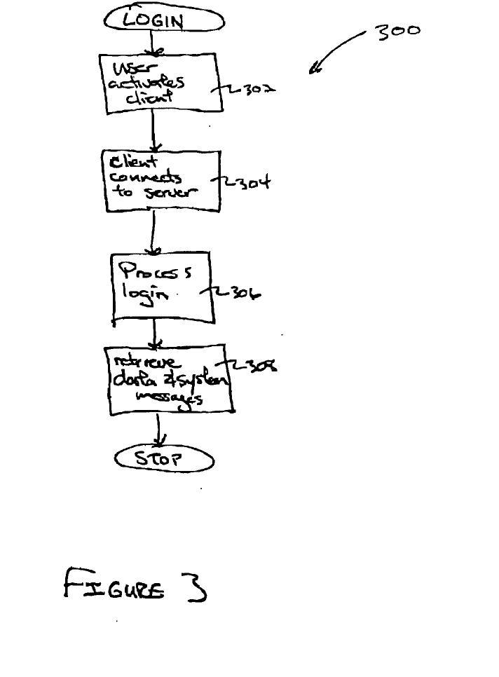

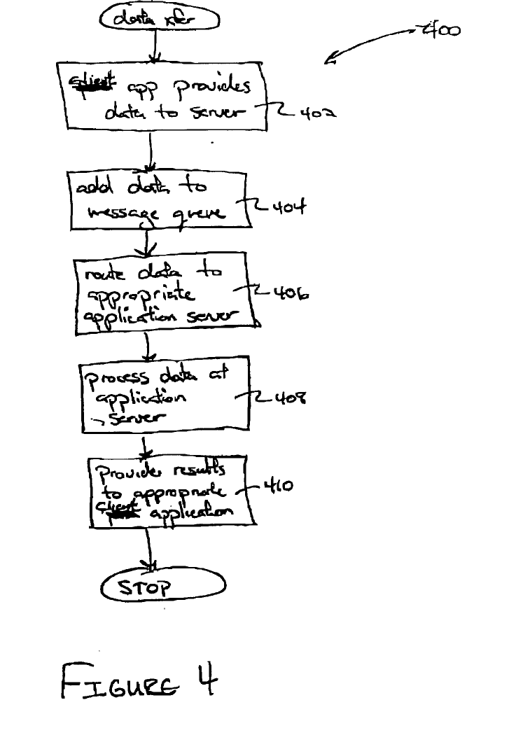

FIG. 2 is a block diagram of an exemplary system 200 for integrated processing of various applications supported by pod applications 100. With reference to FIG. 2, pod applications 100A and 100B suitably communicate with server system 204 via digital network 202. Digital network 202 may be any digital communications network such as the Internet, a corporate intranet, an extranet, the public switched telephone network (PTSN), a wireless or optical network, or any other communications network. Computers running conventional web browsers 204 or other network applications such as email, file transfer, remote login and the like may also use network 202 in tandem with pod applications 100, and indeed multiple pod applications 100, internet browsers 204, and the like may reside on a single computer system operated by a particular user.

Server system 204 suitably includes a firewall 206, a load balancer 208, a web server 222, a messaging service 210, application servers 212, a database 218 and an optional additional storage device 220 communicatively coupled via a server network 214. Server network 214 may include various local area or wide area network segments, and may work in conjunction with one or more high speed data switches 216 such as a gigabit Ethernet switch. In an exemplary embodiment, the various components of server system 204 are connected via a gigabit Ethernet network 214 that is controlled by a Cisco model 6509 or similar Ethernet switch 216, although of course other switches or architectures could be used in alternate embodiments. Network 214 may be isolated from network 202, as appropriate, by a suitable firewall 206 that restricts data packets from passing between the two networks. Exemplary firewall packages include the PIX product available from the Cisco Corporation, and may be used to limit traffic penetrating into network 214 from network 202, thereby making network 214 more resistant to security breaches. Security may also be improved in various embodiments by encrypting data communications between server system 204 and pod applications 100A-B. Encryption may take placing using any form of symmetric, asymmetric, elliptical or other cryptography technique such as secure sockets layer (SSL) encryption, data encryption standard (DES) encryption, RSA encryption, or the like.

Optional load balancer 208 is any device capable of receiving data packets passing through firewall 206 from network 202 and of forwarding the packets to an appropriate messaging or application server for processing. Load balancer 208 performs “load balancing” functions so that workload is suitably assigned between redundant servers to lessen the possibility of one or more servers becoming overburdened while other servers are underutilized. Exemplary load balancer hardware is available from the Cisco, F5 or Nortel corporations, as well as several others. Load balancing may also be performed in software running on a router, workstation or other computing device. Load balancer 208 may be eliminated or modified in certain embodiments that do not use redundant servers or that do not expect traffic to overburden the servers used.

Primary functionality of the server system 204 is provided by one or more server computers coupled to network 214. The use of multiple servers allows for customization and expandability of server system 204. In an exemplary embodiment, server system 204 includes one or more messaging servers 210A-C associated with messaging service 210, one or more application servers 212A-C, a database server associated with database 218 and optional streaming servers (not separately shown in FIG. 2). The various servers may be configured in a “publish/subscribe” mode such that client applications 100 place requests into “mailboxes” associated with the various servers. Similarly, results of processed requests may be placed into mailboxes associated with other applications or particular client applications 100 as described more fully below. Server functionality may be implemented as logically distinct processes on a common hardware device, or may be implemented across a number of workstations or other computers linked via network 214. Although any computing device could host one or more servers in server system 204, in an exemplary embodiment the various servers are hosted on Model E4500 or Netra T1 server platforms available from Sun Microsystems, or with products available from Compaq, IBM, and others.

Message service 210 is any messaging application capable of providing communication services between pod applications 100 and server system 204, as well as between the various servers within system 204. In various embodiments, messaging service 210 suitably acts as a software router for the various messages via a system of message queues (i.e. mailboxes) associated with the various applications, client programs, and other elements operating within system 200. Exemplary embodiments of message service 210 may be implemented with the Tempest Messaging System (TMS) available from Tempest Software Inc. of New York City, N.Y. Alternatively, message service 210 may be implemented with the WebLogic product available from BEA, Inc., the Microsoft Transaction Server available from Microsoft, with products available from IBM or Tibco, or with any other messaging service. Messages sent by and within message server 210 may be in any format, such as the extensible markup language (XML) format.

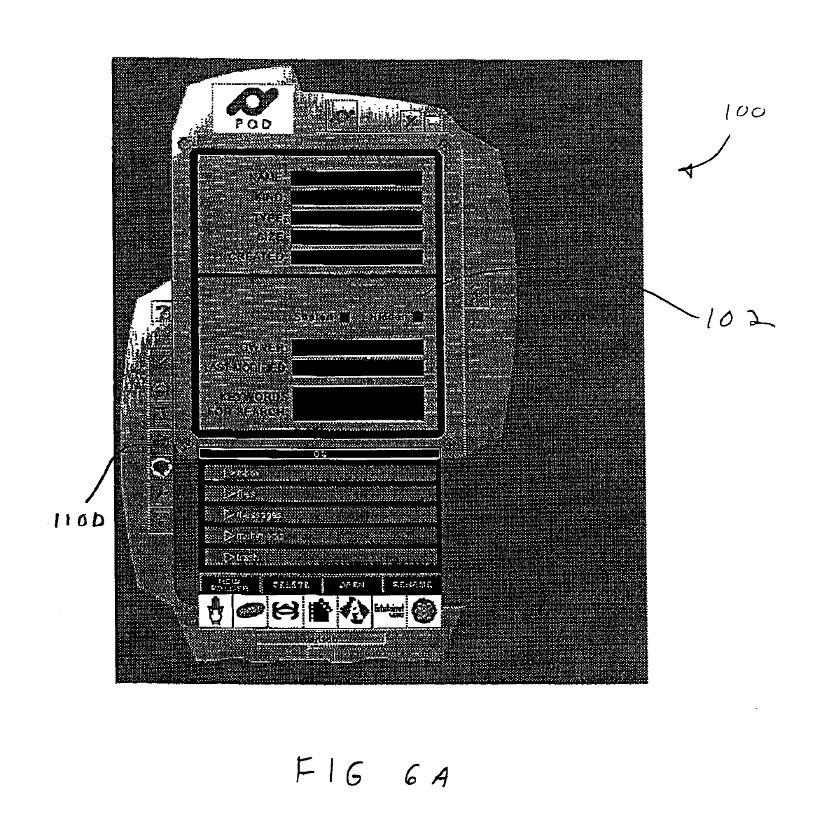

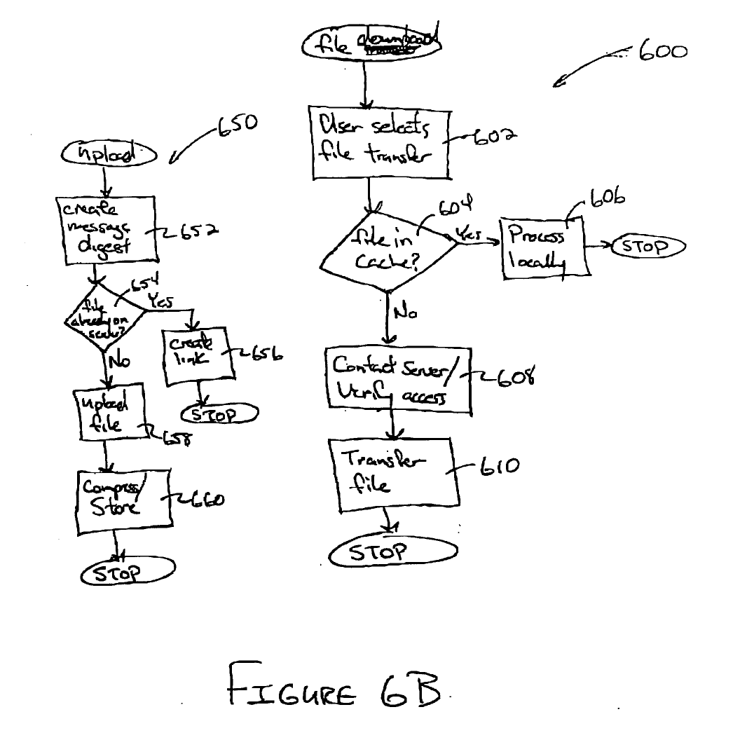

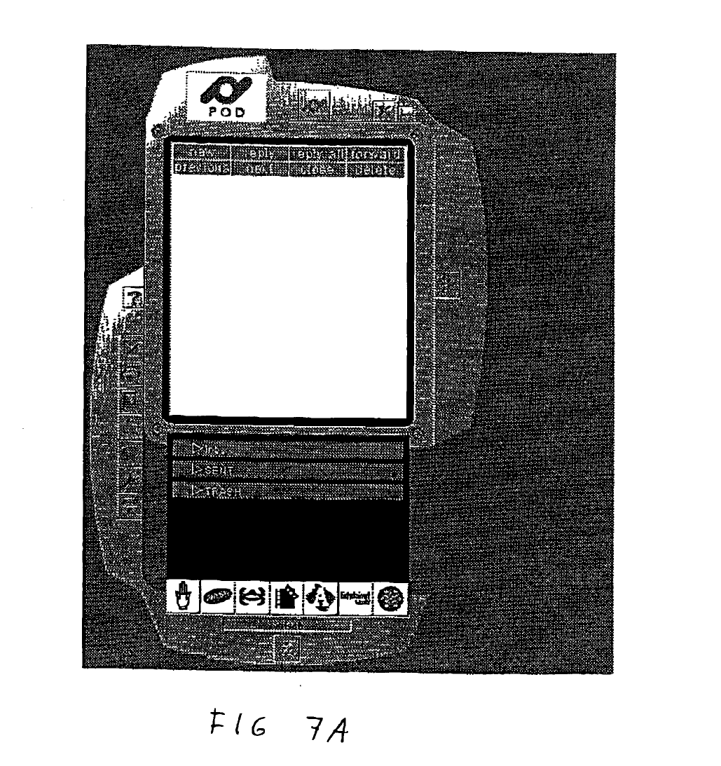

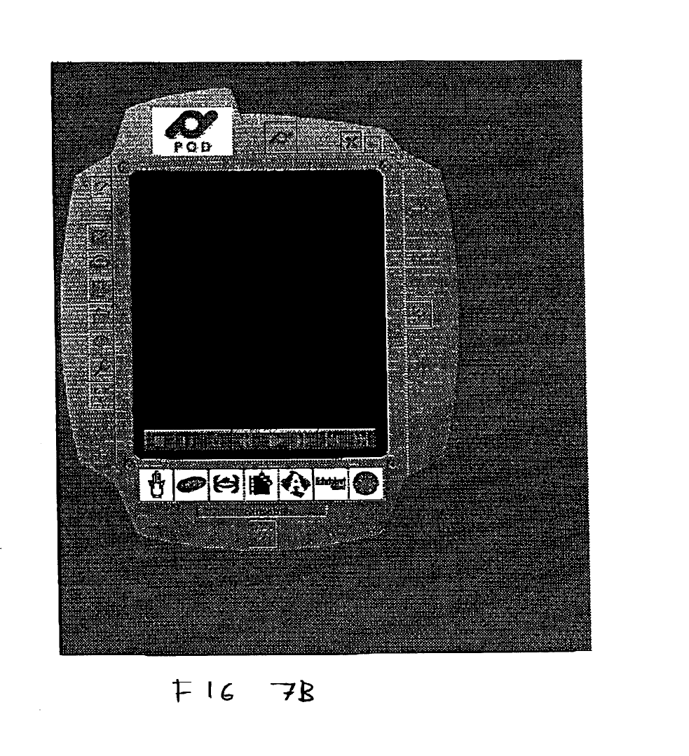

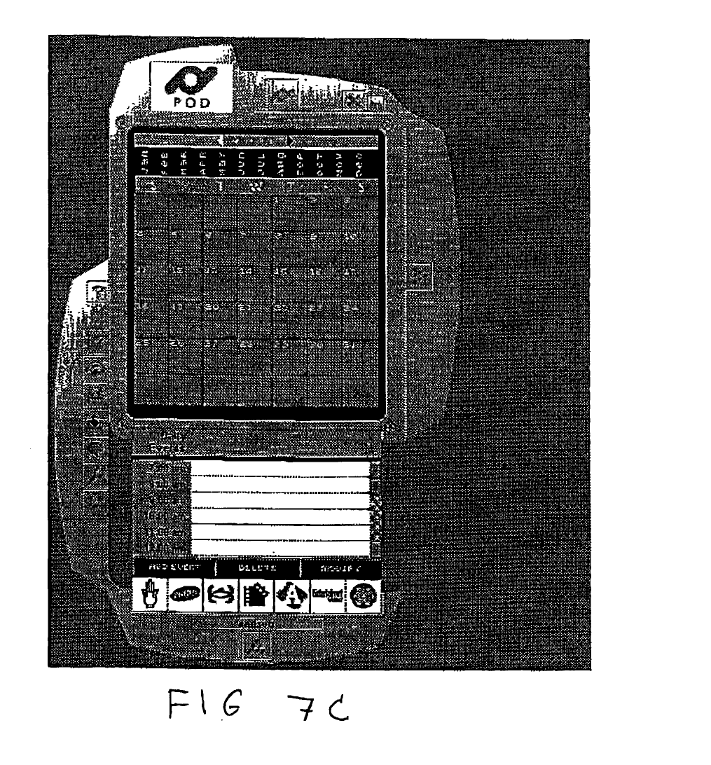

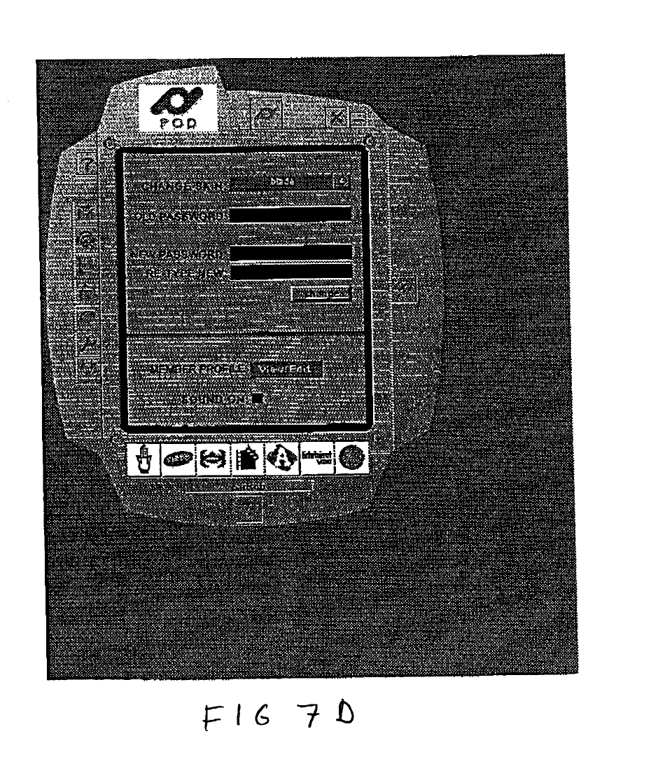

Application servers 212 are any servers capable of processing data messages from pod applications 100 to produce appropriate results. Exemplary application server functions include processing instant messages, processing file transfers, processing email or calendar entries, and the like. In an exemplary embodiment, application servers 212 suitably receive data messages from pod applications 100 and return processed results messages to appropriate pod applications 100 via messaging service 210. Exemplary processes executed at applications servers 212 for instant messaging and file transfer applications are discussed in additional detail below in conjunction with FIGS. 5 and 6, respectively.

Various embodiments suitably redirect processing of certain functions to servers outside of network 213 in addition to or in place of application processing taking place within network 214. Email, calendaring and/or streaming multimedia processing, for example, may be processed at servers maintained by external vendors. In such embodiments, application servers 212 may be configured to forward service requests through firewall 206 to remote servers on network 202, for example. Alternatively, messaging service 210 may suitably forward such requests directly or indirectly to the remote site.

Database 218 is any data structure or repository capable of maintaining information about users, client applications, files stored within system 200, or the like. Database 218 may be implemented with any hierarchical, relational, object-oriented or other database such as with database products available from Sybase, Oracle, IBM or Microsoft. In an exemplary embodiment, database 218 is an Oracle database that suitably maintains information about individual pod applications and files stored within the system in a format that is readily retrievable by the various application servers 212. Database 218 may be associated with an appropriate database server (not shown in FIG. 2) to provide network interface, query processing, and other functionality.

Storage device 220 is any mass storage device (such as one or more RAID systems) capable of storing files and other data used within system 200. In an exemplary embodiment, files uploaded from the various users are processed with a suitable hashing algorithm (such as the MD4 or MD5 algorithm) to create a 128-bit digest corresponding to the file. The digest may then be used to identify the file within the system, and may be used to identify duplicates of the same file (since any duplicates will typically have an identical digest). In such embodiments only a single copy of the file need be stored on device 220. By storing multiple copies of pointers to the file as metadata within database 218, multiple users may be provided with access to a single copy of a file, thus reducing the total amount of storage space used by system 204. Storage space may be further reduced through the use of hardware or software compression techniques prior to storage.

Optional web server 222 is any conventional web or other Internet server that is capable of serving pages over the World Wide Web. Such pages may be useful for promoting system 200 to new users, for providing troubleshooting information or answers to frequently asked questions, and for distributing the client application 100, as described more fully below. Such functionality may be omitted in various embodiments of the invention.

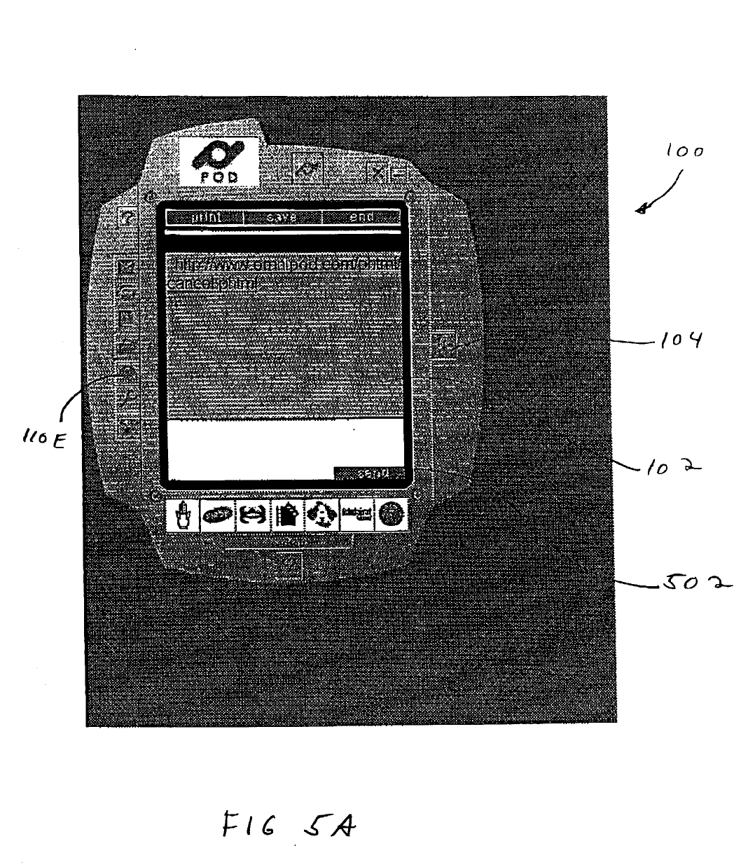

FIG. 3 is a flowchart of an exemplary process for logging into server 204 from a client application 100. With reference now to FIG. 3, an exemplary process suitably begins with a user activating a client application 100 on a client computer (step 302). As discussed briefly above, users may obtain a copy of a client application 100 by retrieving the program with a conventional web browser 204 by “surfing” or otherwise connecting to web server 222. Web server 222 may provide a copy of the client software to the user through the file transfer protocol or any other appropriate technique.

When client program 100 is installed and activated, the user may be prompted to provide an authentication credential such as a userid/password, digital signature or the like. The credential may be manually entered by the user or obtained from a smartcard, fingerprint reader, retina scan or the like. After the credential is obtained, the client application 100 suitably contacts server system 204 via network 202 with a request for connection (step 304). As the request is allowed through firewall 206, load director 208 suitably identifies an appropriate messaging server 210A-C that has available processing capacity and forwards the request to a message queue associated with logins on that server. Messaging server 210 suitably retrieves the request from the queue and processes the login request as appropriate (step 306). Processing the request suitably includes checking the authenticity of the digital credential against an entry in database 218, creating a mailbox on the messaging server 210, and replying to the client application 100 indicating whether the login was successful. Messaging server 210 may also store the address of the client mailbox in database 218 or in a routing table maintained elsewhere in system 204 so that other messages, queries, users, and the like can find the particular client application 100 after it is logged in. In various embodiments, the client mailbox created on messaging server 210 remains at a constant location throughout the login session, referred to as a “sticky connection”.

After the login process is complete, server system 204 provides various information to the client application 100 from database 218. An interface skin, buddy list, file list (or portion of a file list) and other information may be downloaded to client application 100 if such information is not already locally stored. System messages (which may be in HTML format, for example) may also be downloaded and displayed in display window 102 of client application 100. Server 204 may also log the user into an email and/or calendar system, as appropriate. The user is then ready to use the client application 100. An optional “heartbeat” monitor may also be provided which “pings” or otherwise detects the continued presence of client application 100 on network 202 at a regular interval (e.g. every minute). If the heartbeat monitor determines that client application 100 is no longer active on network 202, server 204 may suitably close the associated mailbox and store any relevant data for the next time client application 100 connects. Client application 100 may also manually logout from server 204 in response to a user instruction.

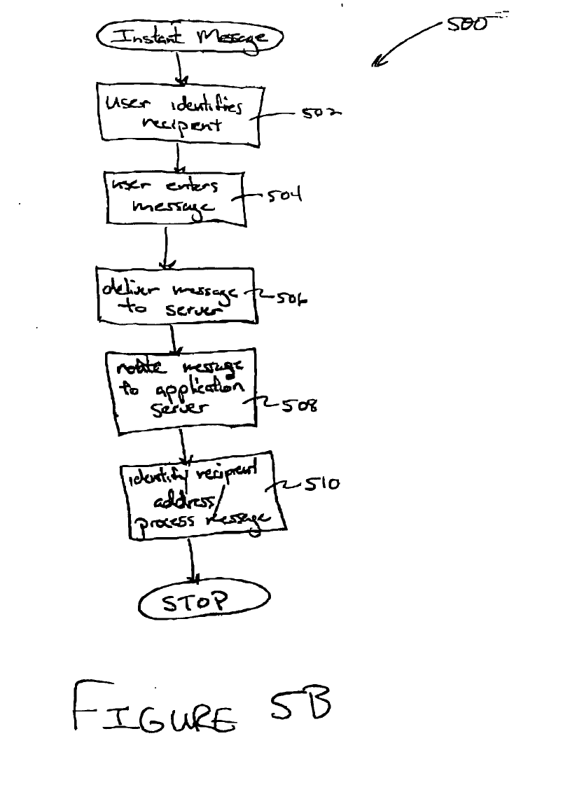

FIG. 4 is a flowchart of an exemplary process for performing a data transfer operation (e.g. a file transfer, an instant message, a calendar entry, an email, or the like). With reference now to FIG. 4, process 400 suitably begins when a user initiates a data transfer by activating the proper interface buttons, menus, etc. on client application 100. Client application 100 suitably contacts server 204 (FIG. 2) to provide the relevant input data (e.g. a file to be transferred, an email message, chat or voice-over-IP data or the like) to server 204 (step 402). In an exemplary embodiment, data messages are uploaded from client application 100 to the associated client mailbox at messaging service 210. Messaging service 210 suitably adds the data to a message queue (step 404) for an appropriate application server 212 to process the data. Data messages may be routed to the application servers (step 406) on an interrupt driven basis whereby messages are provided to the servers as received. Alternatively, data messages are polled from the message queues by the various application servers at regular intervals. In an exemplary embodiment, “push” and “pull” techniques may be combined depending on the type of service being provided, system load, the priority of the message, etc. Data is then processed by the relevant application server 212A-C (step 408) as appropriate. According to the type of service function being provided, application server 212 may store or retrieve information from database 218 and/or mass storage 220. After processing is complete, application server 212 suitably provides any results messages to a message queue/mailbox for the recipient (which may be another application server 212, database 218, mass storage 220, and/or one or more client applications 100) as step 410. Messaging service 210 suitably delivers any results messages as appropriate to mailboxes for the intended recipient(s), which may then retrieve the results from the appropriate mailbox on message service 210. Like input data messages, results messages may be provided to the recipient through any active or passive distribution scheme. For example, messages may be “pushed” to the recipient by message service 210 on an interrupt-driven basis, “pulled” by the recipient at a regular interval, or any combination of these and other methods.

FIGS. 5A and 5B show an exemplary user interface and a flowchart for an exemplary instant messaging application. With reference to FIGS. 5A and 5B, the instant messaging process 500 suitably begins with a user selecting a recipient for the message in client application 100. Recipients may be identified through searching by username, profile information, etc. Alternatively, a user may select a recipient from a “buddy list” (best seen in window 120 in FIG. 1B), or through any other technique. Additionally, recipients may be added to a “buddy list” by dragging their pod identification from a search result to a buddy list, or through manual entry.

After a recipient is selected, the user activates an instant message button (such as button 110E or a button in window 120 (FIG. 1A)) or otherwise activates the instant messaging function to receive a message input window in display 102. The user suitably enters a message to be delivered (step 504) via the interface in window 102, and depresses a “send” button 502 to deliver the message contents to server 204 (step 506), along with identifiers for the sender and recipient. The input data message is provided to a mailbox in messaging system 210, as appropriate, which forwards the message to an appropriate application server 212A-C configured for processing instant messages (step 508). Application server 212 suitably formats and/or forwards the message to the recipient's mailbox on messaging system 210. The location of the mailbox may be obtained from a routing table stored at database 218, at messaging system 210, or elsewhere in server system 204 that is updated as client applications 100 log in or out of the server. In various embodiments, the routing table is a distributed state table maintained by the application servers 212 or database 218 and that is populated though queries made to messaging service 210. After the message is placed in the appropriate recipient mailbox, recipient application 100 obtains the message from its associated mailbox through any push, pull or other distribution scheme (which may vary based upon load, activity, message priority, and the like). Recipient client application 100 displays the message to the recipient user as appropriate.

FIGS. 6A and 6B show an exemplary interface and a flowchart for an exemplary file transfer process. With reference now to FIGS. 6A and 6B, the file transfer process suitably begins by the user selecting button 110D on application 100, or by otherwise activating the file transfer function (step 602). In an exemplary embodiment and with momentary reference to FIG. 1B, users may activate the file upload function by simply dragging and dropping a file name from window 122 to a recipient in window 120. Similarly, a user may activate the file download function by dragging a filename from a pod shown in window 120 to a desired location within a file system displayed in window 122. With continued reference to FIG. 6A, users may also identify files to be transferred by completing and submitting a search form to retrieve a list of files meeting the search criteria to which the user has access. With reference now to FIG. 6B, the file download process 600 continues by determining whether the selected file is already stored locally, such as in a cache directory associated with client application 100 (step 604). If so, the file transfer is processed locally (step 606) by simply adding a link to the file in the file system displayed within application 100. If the file is not already stored locally, client application 100 suitably contacts server 204 with a data message containing the identity and/or location of the desired file (step 608). The data message is received by messaging service 210 and forwarded to an appropriate application server 212 as described above. Files stored on server 204 may be physically stored in mass storage 220, with a corresponding database entry about the file (i.e. “metadata”) stored in database 218. Metadata stored about the various files may include the digest/hash result described above, a file name and/or a list of permissions associated with the file. Files may be made available to all users of the system, for example, to a limited subset, or only to the party that uploaded the file. If the user requesting the file has the appropriate permissions, application server 212 suitably locates the file within server 204, retrieves the file from storage (e.g. from mass storage 220) and administers transfer of the file from server 204 to client application 100. Alternatively, if the user does not require local storage of the file, user's account with server 204 may receive a pointer to the desired file's location on server 204 such that the file appears in the client application's file system even though the file resides on server 204. In such a way multiple users may have simultaneous access to files stored on server 204 without the need for storage of multiple copies of the file.

If a user desires to make a file on a local file system available to other users or if the user wants to store a copy of the file on server 204 (for example for backup purposes or to access the file from remote locations), the user may upload a copy of the file to server 204 using exemplary upload process 650. Client application 100 suitably creates a digest of the file to be transferred by passing the file through an algorithm such as a hash algorithm (step 652). Exemplary algorithms include the MD4 and MD5 algorithms, which create a 128-bit message digest based upon the content of the file. The digest suitably acts as a “fingerprint” or identifier for the file that can be used to determine if another copy of the file is already stored on server 204. The digest may be provided to an appropriate application server 212 as described above, which then queries database 218 (step 654) to determine if an identical version of the file is already stored within server 204 as appropriate. If a copy of the file already exists on the server, the file need not be uploaded from the user's local file system. Instead, a pointer or link to the copy already in storage may be added to the users' network file system so that the user may access the file in the future (step 656).

If an identical file is not already stored on server 204, the file is suitably uploaded by an appropriate application server 212 (step 658) and stored within mass storage 220, or elsewhere within server 204 as appropriate (step 660). Application server 212 may also create a entry in database 218 for the file to store the message digest/identifier as well as any desired permissions, links to users, etc. In various embodiments, files are compressed prior to storage. In such embodiments, the download process would suitably include a step to decompress the file either prior to or after transfer to client application 100. Whether the actual file is uploaded or whether a link to an existing copy of the file is created, permissions to view or execute the file may be modified by the user and stored in database 218 as appropriate.

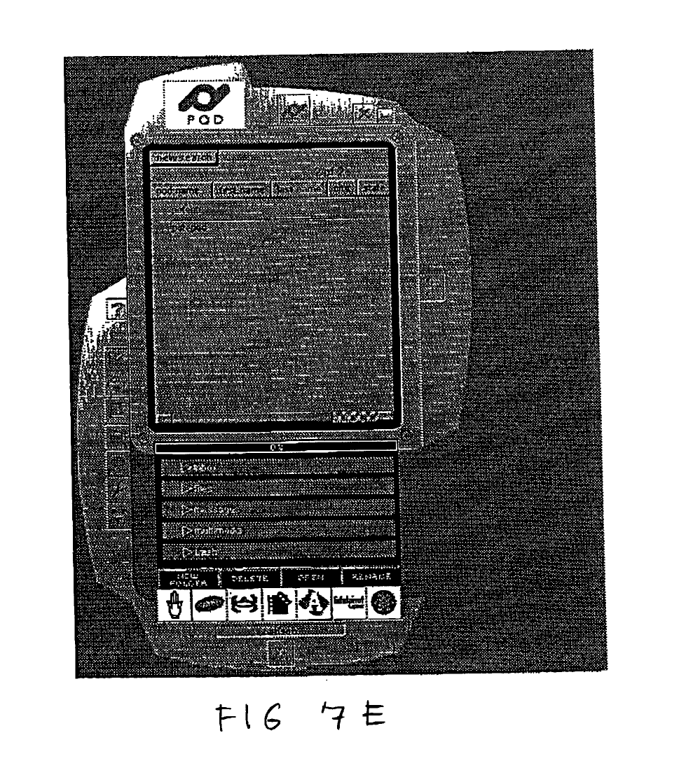

FIGS. 7A-E show exemplary user interfaces for exemplary email, multimedia player, calendar, utility, and pod universe functions, respectively. It will be appreciated that any additional functionality could be added to the client application 100 by merely adding or modifying the various application servers 212 in server 204. Server 204 thus provides a scalable, flexible network server system that allows data to be stored on a network and shared between multiple users of the network. Similarly, additional functions and features may be added to the server system 204 to create an integrated network application.

The corresponding structures, materials, acts and equivalents of all elements in the claims below are intended to include any structure, material or acts for performing the functions in combination with other claimed elements as specifically claimed. Any steps recited in any method claim may be practiced in the order recited, or in any other temporal or logical sequence. The scope of the invention should be determined by the appended claims and their legal equivalents, rather than by the examples given above. No element described herein should be interpreted as essential to the practice of the invention unless expressly described herein as “necessary” or “required”.

What is claimed is:

1. An integrated system for processing data messages on a data network, the system comprising:
an interface configured to receive said data messages via said data network; a plurality of application servers configured to process said data messages and to create output messages in response thereto; and
a messenger service configured to route said data messages and said output messages between each of said plurality of application servers and said interface.

2. The system of claim 1 wherein said messenger service is further configured to receive said data messages in a plurality of client mailboxes, each of said plurality of client mailboxes corresponding to a client application communicating on said data network.

3. The system of claim 2 wherein said messenger service further comprises a plurality of application mailboxes, wherein each of said plurality of application mailboxes corresponds to one of said application servers.

4. The system of claim 3 wherein said messenger service is further configured to pass each of said data messages to one of said plurality of application mailboxes.

5. The system of claim 4 wherein each of said application servers are further configured to retrieve said data messages from the corresponding one of said application mailboxes prior to processing.

6. The system of claim 5 wherein said messenger service is further configured to pass each of said results messages from one of said plurality of application servers to one of said plurality of client mailboxes.

7. The system of claim 6 wherein said results messages are provided to each of said plurality of client mailboxes via the corresponding one of said client mailboxes.

8. The system of claim 7 wherein said plurality of application servers comprises an instant messaging server and wherein said data messages comprise instant messages composed by users of said plurality of client programs.

9. The system of claim 7 wherein said plurality of application servers comprises a file transfer server and wherein said data messages comprise files to be transferred between users of said plurality of client programs.

10. The system of claim 8 wherein said plurality of application servers further comprises a file transfer server and wherein said data messages further comprise files to be transferred between users of said plurality of client programs.

11. The system of claim 7 wherein said plurality of application servers comprises at least one of the group consisting of: an email server, a multimedia server, a file transfer server, a calendar server, and an instant messaging server.

12. The system of claim 7 wherein said plurality of application servers comprises at least two of the group consisting of an email server, a multimedia server, a file transfer server, a calendar server, and an instant messaging server.

13. The system of claim 7 wherein said plurality of application servers comprises a chat server.

14. The system of claim 7 wherein said plurality of application servers comprises a voiceover-IP server.

15. The system of claim 1 further comprising a database in communication with at least one of said application servers, and wherein said at least one of said application servers is configured to process queries to said database in response to said data messages.

16. A method for exchanging a data message on a data network, the method comprising the steps of:
receiving said data messages via said data network at an interface;
routing said data message from said interface to an application server with a messaging service;
processing said data messages at one of said application servers to create an output messages in response thereto; and
providing said output messages to a recipient via said messaging service.

17. The method of claim 16 wherein said messenger service comprises a client mailbox corresponding to a client application communicating on said data network.

18. The method of claim 17 wherein said messenger service further comprises an application mailbox corresponding to said application server.

19. The method of claim 18 wherein said routing step comprises passing said data message to said application mailbox.

20. The method of claim 19 wherein said application mailbox comprises a message queue.

21. The method of claim 19 wherein said providing step further comprises passing said results message from said application server to said client mailbox via said messaging service.

22. The method of claim 21 wherein said providing step further comprises passing said results message from said client mailbox to said recipient.

23. The method of claim 16 wherein said processing step comprises processing an instant message.

24. The method of claim 16 wherein said processing step comprises processing a file transfer.

25. A system for executing the method of claim 16.

26. A system for executing the method of claim 22.
